(19) United States
(12) Patent Application Publication
(10) Pub. No.: US 2010/0278127 A1
(43) Pub. Date: Nov. 4, 2010

(54) WIRELESS COMMUNICATION METHOD, AND A PICONET COORDINATOR, WIRELESS LOCAL AREA NETWORK, AND A MOBILE APPARATUS FOR WIRELESS LOCAL AREA NETWORK USING THE METHOD

(76) Inventors: Haesook Jeon, Daejeon (KR); Kyunghee Lee, Daejeon (KR); Seungmin Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/747,457

(22) PCT Filed: Aug. 22, 2008
(86) PCT No.: PCT/KR08/04908

§ 371 Date: Jun. 10, 2010

(30) Foreign Application Priority Data
Dec. 11, 2007 (KR) 10-2007-0128161

(51) Int. Cl. H04W 72/04

(52) U.S. Cl. 370/329

(57) ABSTRACT

A wireless communication method according to the present invention reserves a separate alternative channel in addition to a communication channel when a channel allocation request for a channel, in which it is required to secure QoS, is received from a device, and changes a channel to the reserved alternative channel to perform communication when a defective state exceeding an allowable value is detected in observed QoS information with respect to the communication channel. Therefore, it is possible to continuously provide satisfactory QoS.

### TECHNICAL FIELD

The present invention relates to a wireless communication method, a piconet coordinator using the same, a method for a wireless local area network, and a mobile apparatus for a wireless local area network. More particularly, the present invention relates to a wireless communication apparatus and method that is capable of securing QoS (Quality of Service) in a wireless communication network where communication is performed through a point-to-point network. This work was supported by the IT R&D program of MIC/IITA [2007-S-047-01, Development of HD Class Multimedia System Technology over Wireless Home Network].

### BACKGROUND ART

In recent years, as demand on a ubiquitous network increases, a WPAN (Wireless Personal Area Network) technology that wirelessly connects home appliances and various information apparatuses in a local area has attracted attention.

The WPAN technology is a small-sized and low-priced personal wireless network technology that enables communication in a local area in a range of about 10 m and can reduce power consumption, and is anticipated to become the new main technology for implementing ubiquitous networking. The WPAN technology, which is used in a relatively defined area, enables a sensor network to be constructed while providing a high-speed and high-quality wireless Internet service. The WPAN technology enables digitalization of and communication between all home appliances in homes, such as TVs, computers, PDAs, refrigerators, washing machines, and gas/light control sensor devices, and enables all of the home appliances to operate in connection to an external network. Since the WPAN technology enables remote control on all of the home appliances from the outside, it is anticipated that the WPAN technology will be continuously developed.

In recent years, since the trend for a communication environment is leaning toward the integration of wired and wireless technologies, it is anticipated that the communication environment will be developed into a ubiquitous environment such that all computers are connected to each other and users can access information through a network without depending on times and places. In particular, in a field of wireless communication, a local area network (LAN), such as a WPAN and a WLAN (Wireless Local Area Network), and a Mesh network and an ad-hoc network are being considered as the main technologies for implementing ubiquitous networking. Therefore, the related standardization and technology development are actively progressing throughout the world. It is anticipated that the size of the market in the related industry will increase on a large scale.

Various standards are defined to allow data communication to be performed through a wireless local area network. The IEEE 802.11 mainly defines the standard for the WPAN and the IEE 802.15 mainly defines the standard for the WPAN. A high rate WPAN (HR-WPAN) focuses on a technology that increases a data transmission speed, develops a MAC (Medium Access Control) technology for high-speed data transmission, considerably decreases power consumption, and accommodates various types of applications.

The HR-WPAN technology that is developed by the IEEE 802.15.3 TG (Task Group) is used for high-speed multimedia transmission between wireless terminals in a local area in a range of 5 to 55 m. However, a low rate WPAN (LW-WPAN) is a technology for a local area network in a range of 10 to 20 m in wireless networking in homes or offices and ubiquitous computing that attracts attention in recent years. The LW-WPAN simplifies operation/maintenance and defines hardware, software, and application profile technologies that require low power and low costs, and the interoperability between apparatuses, security, and test/authentication standard. Finally, there is a location recognition WPAN technology. This technology defines an alternative PHY to the designated low-speed WPAN standard for various sensors used in the low-speed WPAN, remote control, and home automation.

A network that is defined by the IEEE 802.15.3 is called a piconet. The piconet is managed by a network controller that is called a piconet coordinator (PNC). A wireless communication resource is managed according to the version information of the piconet. When a device (DEV) that desires communication transmits data, a channel to be used in advance is reserved, and a CTA (Channel Time Allocation) zone is used to allow data to be transmitted in only the corresponding time zone. The piconet transmits a beacon to each device at a predetermined time interval so as to synchronize a channel. When desiring to change a channel, the piconet sets a count field of the beacon to change a channel, and transmits it to each of the devices.

According to the set count field value, the beacon needs to be transmitted many times, such that the channel can be changed. That is, even though the channel quality of each device is low at the time when the current channel is changed to the new channel, each device has no choice but to use the corresponding channel and perform communication. Accordingly, it is not possible to secure the channel quality for the corresponding time.

### DISCLOSURE

### Technical Problem

The present invention has been made to solve the above-described problems, and it is an object of the present invention to provide a wireless communication method, a piconet coordinator using the same, a method for a wireless local area network, and a mobile apparatus for a wireless local area network that are capable of preventing communication interruption from occurring due to a channel change from a current channel to a new channel, when a state of the current channel is bad.

### Technical Solution

According to an aspect of the present invention, a wireless communication method includes reserving a separate alternative channel in addition to a communication channel, when a channel allocation request for a channel, in which it is required to secure QoS, is received from a device; and switching the channel for communication to the reserved alternative channel when a defective state exceeding an allowable value is detected in observed QoS information with respect to the communication channel.

Reserving the alternative channel may include determining whether a corresponding channel is a general channel or the channel in which it is required to secure QoS when the channel allocation request is received, and storing related information in a QoS management list when it is determined that the corresponding channel is the channel in which it is required to secure QoS. The QoS information may include information on at least one of a delay, a jitter, and a bandwidth, and the defective state exceeding the allowable value may indicate that the number of times poor channel conditions are detected is equal to or larger than a value set by a communication system.

Switching the channel for communication to the alternative channel may include transmitting the observed QoS information to the device when the corresponding device requests to provide QoS information.

In the wireless communication method, switching the channel for communication to the alternative channel may further include allowing the device that has received the QoS information to change device setting to be adapted to a current network situation according to the received QoS information.

The wireless communication method may further include, after switching the channel to the reserved alternative channel, withdrawing the current communication channel.

Time slots in super frames that time-divide the channel may be used as the alternative channel. When a multichannel is provided, time slots in super frames that time-divide another channel instead of a current channel may be used as the alternative channel. Time slots in super frames that time-divide a current channel may be used as the alternative channel.

According to another aspect of the present invention, a piconet coordinator includes a channel separating unit that receives a channel allocation request from a device, and determines whether it is required to secure QoS in the allocation requested channel; and a monitoring processing unit that reserves a separate alternative channel in addition to a communication channel with respect to the channel in which it is required to secure QoS, and, when a defective state exceeding an allowable value is detected in observed QoS information with respect to the communication channel, switches a channel to the alternative channel to perform communication with the device.

According to still another aspect of the present invention, a method for a wireless local area network includes allowing a device to transmit a channel allocation request; allowing a piconet coordinator to receive the channel allocation request from the device and to determine whether it is required to secure QoS in an allocation requested channel; allowing the piconet coordinator to reserve a separate alternative channel in addition to a communication channel when the allocation requested channel is a channel in which it is required to secure QoS; and allowing the piconet coordinator to instruct the device to switch a channel to the reserved alternative channel and to change its channel to the reserved alternative channel, when a defective state exceeding an allowable value is detected in observed QoS information with respect to the communication channel.

According to a further aspect of the present invention, there is provided a mobile apparatus for a wireless local area network. In this case, a channel allocation request for a channel, in which it is required to secure QoS, is transmitted to a piconet coordinator, communication is performed through a communication channel that is allocated by the piconet coordinator, and when a command that instructs to switch the communication channel to an alternative channel is received from the piconet coordinator during the communication, the communication channel is switched to the received alternative channel.

### Advantageous Effects

According to the present invention, when it is determined that the quality of a corresponding channel is low due to a reservation of an alternative channel in the case where it is required to secure QoS, observed QoS information is transmitted to a corresponding device to provide information such that the device can be adapted in a current network situation or allow a channel to be changed to the reserved alternative channel, thereby continuously providing satisfactory QoS.

### DESCRIPTION OF DRAWINGS

FIG. 1 is a conceptual diagram illustrating a piconet that is a wireless local area network according to an embodiment of the present invention.

FIG. 2 is a functional block diagram of a piconet coordinator according to the present invention.

FIG. 3 is a diagram illustrating formats of super frames that constitute a channel of a piconet to which the present invention is applied.

FIG. 4 is a diagram illustrating a format of a MAC frame that is used in a piconet.

FIG. 5 is a flowchart illustrating the operation of a piconet according to an embodiment of the present invention.

FIG. 6 is a flowchart illustrating a method in which a piconet coordinator allocates a channel and an alternative channel according to the preferred embodiment of the present invention.

FIG. 7 is a flowchart illustrating a process of detecting quality of a channel for QoS and converting the channel into an alternative channel according to the present invention.

### BEST MODE

Hereinafter, the preferred embodiments of the present invention will be described with reference to the accompanying drawings.

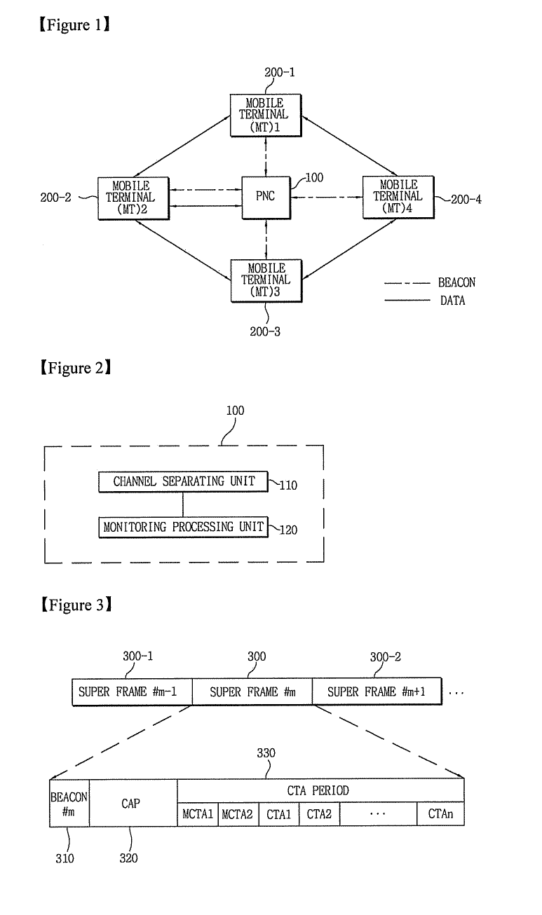

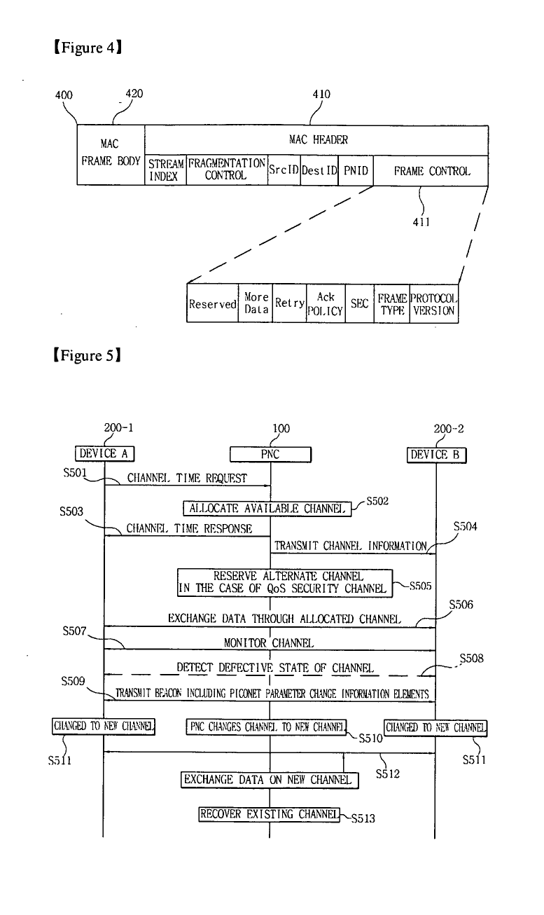

FIG. 1 is a conceptual diagram of a piconet that is a wireless local area network according to an embodiment of the present invention.

Referring to FIG. 1, a piconet is a wireless ad hoc data communication system that enables data communication between a plurality of independent devices. The piconet enables data communication between a plurality of devices 200-1 and 200-2.

FIG. 2 is a functional block diagram of a piconet coordinator according to the present invention. A piconet coordinator 100 according to the present invention includes a channel separating unit 110 and a monitoring processing unit 120.

The channel separating unit 110 grasps channel characteristics of a transmitting unit that requires a channel. When it is required to secure QoS, the channel separating unit 110 uses a method of adding a corresponding channel to a QoS management list or completely performs channel management to classify a channel where it is required to secure QoS. A general channel and a channel where it is required to secure QoS are processed by the same method. That is, the channel separating unit 110 allocates a requested channel and transmits the allocated channel to a transmitting/receiving device.

Meanwhile, the monitoring processing unit 120 periodically inspects whether characteristics of a channel that is registered in the QoS management list to secure QoS are maintained. The channel separating unit 110 confirms information on the channel that is registered in the management list to secure QoS, inspects a resource to determine whether an alternative channel allocation is possible, and allocates the resource when there is a channel to be additionally allocated. When it is determined by the monitoring processing unit 120 that a channel where it is required to secure QoS does not support QoS due to consecutive errors, the monitoring processing unit 120 transmits the resource reserved in the monitoring processing unit 120 to the transmitting/receiving device, such that QoS is continuously secured.

FIG. 3 is a diagram illustrating formats of super frames that constitute a channel of a piconet to which the present invention is applied.

FIG. 3 shows a channel that includes a plurality of super frames. The super frames are time units that constitute a channel on a time axis, that is, time slots. One super frame is divided into a beacon #m, a CAP (Contention Access Period), and a CFP (Contention Free Period). The beacon #m is used to provide basic timing to each of the devices and exchange information for communication management of the piconet. For this purpose, the beacon #m includes a plurality of information elements (IE) and parameters that are used for synchronizing the piconet. Each device 200 and the piconet coordinator 100 can use sections allocated to the information elements (IE) to exchange necessary information with each other.

A CAP (Contention Access Period) 320 is used to exchange commands or transmit asynchronous data. Here, the CAP may be selectively used. A CTA (Channel Time Allocation) 330 is used to exchange commands or transmit a stream or asynchronous data. An MCTA (Management Channel Time Allocation) is a CTA for management. In this invention, to reserve an additional alternative channel means that the CTA is allocated. This is based on the specification of the WPAN that has been introduced until now. However, in a situation where the standardization changes from a single channel to a multichannel, this portion may become a CTA in a single channel or a CTA portion of another channel instead of a current channel. That is, in this invention, the additional alternative channel reservation is made on other resources that are not being used for data transmission.

FIG. 4 shows a format of a MAC frame that is used in a piconet.

A MAC frame 400 includes a MAC header 410 and a MAC frame body 420. A variety of information of a MAC layer for communication is contained in the MAC header 410, and data is loaded in the MAC frame body 420. The data indicates information or data that is exchanged between each device 200 and another device.

In the MAC header 410, if a frame type of a portion of frame control 411 is 0, it indicates a beacon frame. The beacon frame delivers information elements and piconet parameter change information elements. If the MAC header 410 has a frame type of 1, it indicates an immediate ACK, and if the MAC header 410 has a frame type of 2, it indicates a delayed ACK. If the MAC header 410 has a frame type of 3, it indicates a command, and if the MAC header 410 has a frame type of 4, it indicates data.

When the frame type of the MAC header 410 indicates a command, it is possible to process a channel time request response, a channel state request response, and a remote scan and response. A channel time request block field includes requirements of the transmitting unit. A stream request ID to distinguish a corresponding stream request serves as a key that allows the request from the device to be recognized. In the case of a synchronous stream, the number of target devices is limited to one, and in the case of an asynchronous stream, a maximum of 127 target devices are allowed. For example, in the case where a stream is an asynchronous stream and the number of targets is 5, only one alternative channel is reserved, similar to the synchronous stream.

FIG. 5 is a flowchart illustrating the operation of a piconet according to an embodiment of the present invention.

A device A (200-1) transmits a channel time request message to request a communication channel with a device B (200-2) to the piconet coordinator 100 (Step S501). In a general network, this portion can be called a bandwidth. In a wireless network environment, this portion corresponds to a maximum bandwidth that can be provided by the total number of time slots in one channel.

If an available channel exists at the present time, the piconet coordinator allocates the corresponding channel (S502), and notifies the devices A and B (200-1 and 200-2) of the channel allocation (S503 and S504). When the channel needs to secure QoS, the piconet coordinator reserves an alternative channel (Step S505).

Data is exchanged between the device A (200-1) and the device B (200-2) through the allocated channel (S506). While the data is exchanged, the piconet coordinator periodically monitors a channel state (Step S507). The channel state is monitored using a channel state request/response or a remote scanning request/response.

As a monitored result for the channel state, when it is determined that the number of times of occurrence of information, which informs that the quality of the corresponding channel is low, exceeds the predetermined number, that is, when it is determined that the channel state is bad (S508), the piconet coordinator transmits the observed QoS information (a delay, a jitter or a bandwidth) to the corresponding device such that the device is adapted to a new network situation, or informs information on a channel reserved as an alternative channel of the corresponding device. At this time, the piconet coordinator transmits a beacon including the piconet parameter change information elements to each of the devices (S509).

Each of the device A (200-1) and the device B (200-2) that have received the information changes the corresponding channel to a new channel during the time that is defined in the received piconet parameter change information elements (S510). At this time, the time, during which each of the devices should change the channel according to a channel change command, is short such that immediately after each of the devices reads the message, each of the devices can change its state. The piconet also changes the channel to a new channel (S511). The two devices A and B (200-1 and 200-2) exchange data with each other through the new channel (S512). The piconet coordinator 100 recovers a channel that has been allocated for the data (S513).

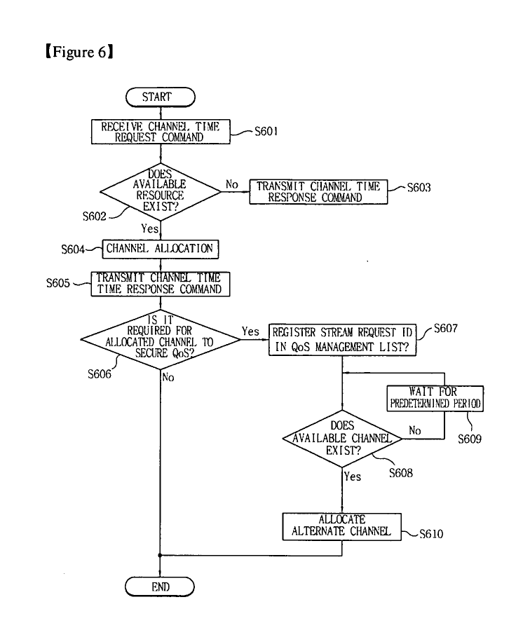

FIG. 6 is a flowchart illustrating a method in which a piconet coordinator allocates a channel and an alternative channel according to the preferred embodiment of the present invention. When the piconet coordinator 100 receives a channel request command (S601), the piconet coordinator 100 determines whether there is an available resource at the present time (S602). When it is determined that there is no available resource (No of S602), the piconet coordinator 100 returns the channel time response command, which includes a message informing that there is no available resource, to the corresponding device (S603). When it is determined that there is an available resource (Yes of S602), the piconet coordinator 100 allocates a channel (S604), and returns the channel time response command including information on the allocated channel to the corresponding device (S605). The piconet coordinator determines that the allocated channel needs to secure QoS (S606). When it is determined that the allocated channel needs to secure QoS, the piconet coordinator registers the corresponding stream request ID in a QoS management list (S607). If the allocated channel is a general channel that is not necessary to secure QoS, a routine ends.

In order to allocate the alternative channel, in regards to the item that is registered in the QoS management list of the piconet coordinator 100, it is determined whether there is a channel that satisfies requirements from the QoS-related device (S608). When it is determined that there is a channel that satisfies the requirements from the QoS-related device, the piconet coordinator reserves the alternative channel (S610). When it is determined that there is no available channel (No of S608), the piconet coordinator periodically asks whether a channel can be allocated (S609 and S608).

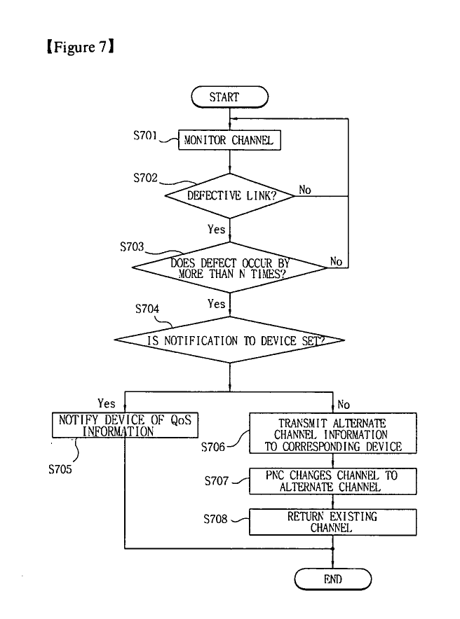

FIG. 7 is a flowchart illustrating a process of detecting quality of a channel for QoS and converting the channel into an alternative channel according to the present invention. With respect to channel items that are stored in the QoS management list according to the present invention, channel monitoring is performed (S701). Specifically, a channel state request/response command or a remote scanning request/response command is used. If it is determined that a link is a defective link (S702), it is determined whether a defect continuously occurs by more than N times that are defined by a system (S703). When it is determined that the defect does not continuously occur by more than N times, the channel is monitored again (S701). When it is determined that the defect continuously occurs by more than N times (Yes of S703), it is determined whether it is set to inform information on the occurred error to the corresponding device (S804). When it is determined that it is set to inform the information to the corresponding device, the observed QoS (a delay, a jitter, and a bandwidth) information is transmitted to the corresponding device (S705). The device uses the received information and adapts to a current network situation.

When it is not set to inform the occurred error information to the corresponding device, the alternative channel information is notified to the corresponding device (S706). At this time, the piconet coordinator also changes the channel to the alternative channel (S707), and updates the related information. In this case, the observed QoS information is transmitted using the parameter conversion information elements. At this time, it is possible to transmit the observed QoS information that includes information on a delay, a jitter, and a current bandwidth. Here, giving an opportunity capable of being adapted to the network situation to the device N times may be defined in advance as QoS. On the basis of the number of counts, the number of counts is reduced whenever the information is notified to the device. When it is not necessary to provide the network information to the device, the channel is changed to the reserved channel. This information may be used or not be used according to the previous QoS reservation. When the PNC changes the channel to the alternative channel, the PNC returns the existing channel that is being used (S708), and ends the monitoring on the corresponding channel. When the piconet coordinator attempts to remove a specific device or a device attempts to leave from the piconet coordinator, or the piconet coordinator attempts to stop transmission of specific data of the device, the piconet coordinator stops monitoring, which is required to secure QoS, and the corresponding channel is deleted from the QoS management list.

Although the present invention has been described in connection with the preferred embodiments of the present invention, it will be apparent to those skilled in the art that various changes and modifications can be made without departing from the technical spirit and scope of the present invention.

1. A communication method comprising:
reserving a separate alternative channel in addition to a communication channel, when a channel allocation request for a channel, in which it is required to secure QoS, is received from a device; and
switching the channel for communication to the reserved alternative channel when a defective state exceeding an allowable value is detected in observed QoS information with respect to the communication channel.

2. The communication method of claim 1, wherein reserving the alternative channel includes:
determining whether a corresponding channel is a general channel or the channel in which it is required to secure QoS when the channel allocation request is received, and storing related information in a QoS management list when it is determined that the corresponding channel is the channel in which it is required to secure QoS.

3. The communication method of claim 1, wherein the QoS information includes information on at least one of a delay, a jitter, and a bandwidth.

4. The communication method of claim 1, wherein the defective state exceeding the allowable value indicates that the number of times poor channel conditions are detected is equal to or larger than a value set by a communication system.

5. The communication method of claim 1, wherein switching the channel for communication to the alternative channel includes:
transmitting the observed QoS information to the device when the corresponding device requests to provide QoS information.

6. The communication method of claim 5, wherein switching the channel for communication to the alternative channel further includes:
allowing the device that has received the QoS information to change device setting to be adapted to a current network situation according to the received QoS information.

7. The communication method of claim 1, further comprising:
withdrawing the current communication channel after switching the channel to the reserved alternative channel.

8. The communication method of claim 1, wherein time slots in super frames that time-divide the channel are used as the alternative channel.

9. The communication method of claim 1, wherein, when a multichannel is provided, time slots in super frames that time-divide another channel instead of a current channel are used as the alternative channel.

10. The communication method of claim 1, wherein, when a multichannel is provided, time slots in super frames that time-divide a current channel are used as the alternative channel.

11. A piconet coordinator comprising:
a channel separating unit that receives a channel allocation request from a device, and determines whether it is required to secure QoS in the allocation requested channel; and
a monitoring processing unit that reserves a separate alternative channel in addition to a communication channel with respect to the channel in which it is required to secure QoS, and, when a defective state exceeding an allowable value is detected in observed QoS information with respect to the communication channel, switches a channel to the alternative channel to perform communication with the device.

12. The piconet coordinator of claim 11, wherein the channel separating unit stores related information in a QoS management list when it is required to secure QoS in the allocation requested channel.

13. The piconet coordinator of claim 11, wherein the QoS information includes information on at least one of a delay, a jitter, and a bandwidth.

14. The piconet coordinator of claim 11, wherein the defective state exceeding the allowable value indicates that the number of times poor channel conditions are detected is equal to or larger than a value set by a communication system.

15. The piconet coordinator of claim 11, wherein, when the defective state exceeding the allowable value is detected in the observed QoS information with respect to the communication channel and the corresponding device requests to provide the QoS information, the monitoring processing unit transmits the observed QoS information to the corresponding device.

16. The piconet coordinator of claim 11, wherein the current communication channel is withdrawn after switching the channel to the reserved alternative channel.

17. A communication method for a wireless local area network comprising:
allowing a device to transmit a channel allocation request;
allowing a piconet coordinator to receive the channel allocation request from the device and to determine whether it is required to secure QoS in an allocation requested channel;
allowing the piconet coordinator to reserve a separate alternative channel in addition to a communication channel when the allocation requested channel is a channel in which it is required to secure QoS; and
allowing the piconet coordinator to instruct the device to switch a channel to the reserved alternative channel, and to switch its channel to the reserved alternative channel, when a defective state exceeding an allowable value is detected in observed QoS information with respect to the communication channel.

18. A mobile apparatus for a wireless local area network,
wherein a channel allocation request for a channel, in which it is required to secure QoS, is transmitted to a piconet coordinator,
communication is performed through a communication channel that is allocated by the piconet coordinator, and
when a command that instructs to switch the communication channel to an alternative channel is received from the piconet coordinator during the communication, the communication channel is switched to the received alternative channel.
